(19) United States
(12) Patent Application Publication
(10) Pub. No.: US 2013/0021245 A1
(43) Pub. Date: Jan. 24, 2013

(54) INTERACTIVE CONTENT CONTROL METHOD AND USER INTERFACE APPARATUS USING THE SAME

(71) Applicants: Jae Ho LEE, Daejeon (KR); Ji Young Park, Daejeon (KR); Seung Woo Nam, Daejeon (KR); Hee Kwon Kim, Daejeon (KR)

(72) Inventors: Jae Ho LEE, Daejeon (KR); Ji Young Park, Daejeon (KR); Seung Woo Nam, Daejeon (KR); Hee Kwon Kim, Daejeon (KR)

(73) Assignee: Electronics and Telecommunications Research Institute, Daejeon (KR)

(21) Appl. No.: 13/550,801

(22) Filed: Jul. 17, 2012

(30) Foreign Application Priority Data
Jul. 18, 2011 (KR) 10-2011-0070972

(51) Int. Cl. G06F 3/033

(52) U.S. Cl. 345/158

(57) ABSTRACT

An interactive content control method and a user interface apparatus using the same are provided. The interactive content control method detects a reference length which becomes a reference for controlling interactive content according to a movement of a user, on the basis of skeletal information of the user, detects a comparison length on the basis of the skeletal information, and controls the interactive content according to a result of comparing the reference length and the comparison length. Accordingly, the present invention can provide a highly interactive user interface environment.

### CLAIM FOR PRIORITY

This application claims priority to Korean Patent Application No. 10-2011-0070972 filed on Jul. 18, 2011 in the Korean Intellectual Property Office (KIPO), the entire contents of which are hereby incorporated by reference.

### BACKGROUND

1. Technical Field

Example embodiments of the present invention relate in general to a user interface, and more specifically to an interactive content control method and a user interface apparatus using the same for controlling interactive content according to a user's movement.

2. Related Art

User interfaces are apparatuses or software that facilitate smooth interaction between a user and a system. User interfaces are largely categorized into letter type user interfaces, menu type user interfaces, and graphic user interfaces. Recently, touch screens are widely used as interface apparatuses and enable interaction between a user and a system through a user's touch.

However, in using experiential content (i.e., interactive content) such as sports and racing games, when a touch screen that controls content though simple touch is used as an interface apparatus, a user cannot fully interact with the interactive content. For example, in a boxing game, which is a type of interactive content, content can be fully experienced when the content is controlled according to the actual movement of a user's first, but when the content is controlled by simply touching a touch screen, a user cannot fully interact with the content.

To overcome such limitations, Korean Patent Publication No. 2010-0075282 entitled “Wireless Apparatus and Method for Space Touch Sensing and Screen Apparatus Using Depth Sensor” was filed. However, in the disclosed wireless apparatus and method, since a user's movement is sensed in a certain virtual space but is not sensed in spaces other than the virtual space, a user's movement for controlling content is limited, and thus, a user cannot fully interact with interactive content.

### SUMMARY

Accordingly, example embodiments of the present invention are provided to substantially obviate one or more problems due to limitations and disadvantages of the related art.

Example embodiments of the present invention provide an interactive content control method for controlling interactive content according to a user's movement.

Example embodiments of the present invention also provide a user interface apparatus for controlling interactive content according to a user's movement.

In some example embodiments, an interactive content control method performed by a user interface apparatus includes: detecting a reference length which becomes a reference for controlling interactive content according to a movement of a user, on the basis of skeletal information of the user; detecting a comparison length on the basis of the skeletal information; and controlling the interactive content according to a result of comparing the reference length and the comparison length.

The detecting of the reference length may include: detecting body image information of the user; detecting the skeletal information of the user on the basis of the detected body image information; extracting at least one reference joint and at least two reference bones that are connected to the reference joint from the detected skeletal information; and detecting a value obtained by adding a length of a first reference bone connected to one end of the reference joint to a length of a second reference bone connected to the other end of the reference joint as the reference length.

The detecting of the comparison length may include detecting a linear length between an end portion of a first reference bone connected to one end of the reference joint and an end portion of a second reference bone connected to the other end of the reference joint as the comparison length.

The controlling of the interactive content may include: comparing a size of the reference length and a size of the comparison length; and controlling the interactive content according to a command corresponding to the movement of the user when the comparison length is greater than or equal to the reference length as the comparison result.

In other example embodiments, a user interface apparatus includes: a display unit configured to display interactive content controlled according to a command corresponding to a movement of the user; a sensor unit configured to detect body image information based on the movement of the user; and a user interface configured to detect skeletal information on the basis of the body image information detected by the sensor unit, detect a reference length and a comparison length on the basis of the skeletal information, compare the reference length and the comparison length, and control the interactive content displayed by the display unit according to the comparison result.

The user interface apparatus may further include a portable terminal connected to the interface unit over a communication network and configured to display the interactive content controlled according to the command corresponding to the movement of the user, wherein the interactive content displayed by the portable terminal is controlled by the interface unit.

The portable terminal may further include a function which transmits a control signal for controlling the interactive content to the interface unit according to a request of the user and displays the interactive content controlled by the interface unit according to the control signal.

The interface unit may extract at least one reference joint and at least two reference bones connected to the reference joint from the skeletal information, detect a value obtained by adding a length of a first reference bone connected to one end of the reference joint to a length of a second reference bone connected to the other end of the reference joint as the reference length, and detect a linear length between an end portion of a first reference bone connected to one end of the reference joint and an end portion of a second reference bone connected to the other end of the reference joint as the comparison length.

The interface unit may control the interactive content according to the command corresponding to the movement of the user when the comparison length is greater than or equal to the reference length.

### BRIEF DESCRIPTION OF DRAWINGS

These and other features, objects, and advantages of the present invention will become more apparent by describing in detail example embodiments of the present invention with reference to the accompanying drawings, in which:

FIG. 1 is a flowchart illustrating an interactive content control method according to an embodiment of the present invention;

FIG. 2 is a conceptual diagram illustrating detected body image information;

FIG. 3 is a conceptual diagram illustrating detected skeletal information;

FIG. 4 is a rendering of a human skeleton; and

FIG. 5 is a block diagram illustrating a configuration of a user interface apparatus according to an embodiment of the present invention.

### DESCRIPTION OF EXAMPLE EMBODIMENTS

The invention may have diverse modified embodiments, and thus, example embodiments are illustrated in the drawings and are described in the detailed description of the invention.

However, this does not limit the invention within specific embodiments and it should be understood that the invention covers all the modifications, equivalents, and replacements within the idea and technical scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

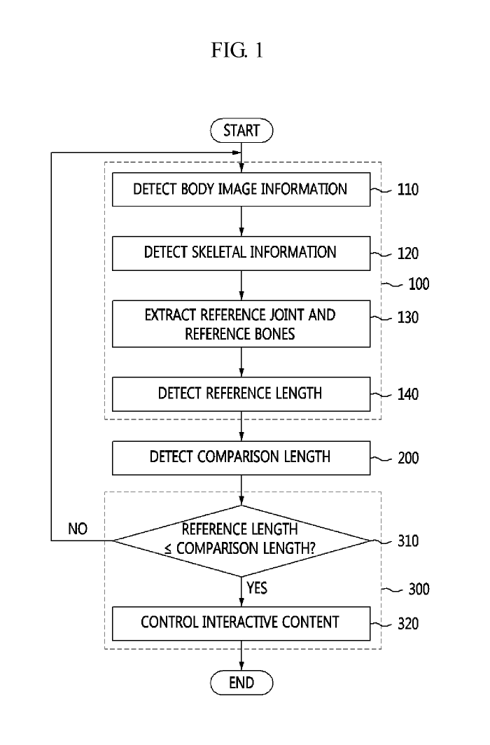

FIG. 1 is a flowchart illustrating an interactive content control method according to an embodiment of the present invention. The interactive content control method includes: step 100 of detecting a reference length which becomes a reference for controlling interactive content according to a user's movement on the basis of skeletal information of the user; step 200 of detecting a comparison length on the basis of the skeletal information; and step 300 of controlling interactive content according to a result of comparing the reference length and the comparison length.

Here, the interactive content control method according to an embodiment of the present invention is performed in a user interface apparatus illustrated in FIG. 5.

Step 100 is an operation of detecting the reference length which becomes the reference for controlling the interactive content according to the user's movement on the basis of the user's skeletal information, and includes: operation 110 of detecting body image information of the user; operation 120 of detecting the skeletal information of the user on the basis of the detected body image information; operation 130 of extracting at least one reference joint and at least two reference bones are connected to the reference joint from the detected skeletal information; and operation 140 of detecting a value obtained by adding a length of a first reference bone connected to one end of the reference joint to a length of a second reference bone connected to the other end of the reference joint as the reference length.

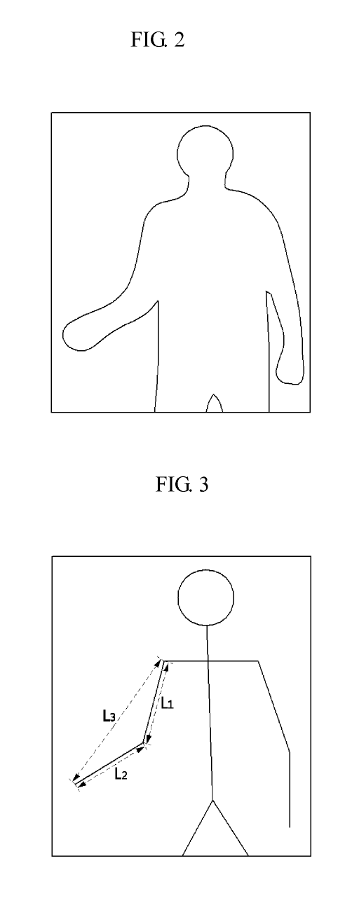

Operation 110 is an operation of detecting the body image information of the user. The body image information is detected by a sensor unit 20 (see FIG. 5), and the detected body image information is as illustrated in FIG. 2. That is, the body image information denotes the external appearance of the user. In this case, the interactive content control method may detect only the body image information of the user, or detect body video information of the user and extract the body image information from the detected body video information.

The interactive content is controlled according to a command corresponding to the user's movement, and thus, operation 110 involves detecting the body image information on the user's movement corresponding to a command for controlling the interactive content. For example, when the interactive content is controlled according to a command corresponding to the user's arm movement, operation 110 involves detecting body image information including the user's arm, and when the interactive content is controlled according to a command corresponding to the user's leg movement, operation 110 involves detecting body image information including the user's leg.

Operation 120 is an operation of detecting the skeletal information on the basis of the body image information detected in operation 110. The skeletal information is detected by an image processor 31 (see FIG. 5), and the detected skeletal information is as illustrated in FIG. 3.

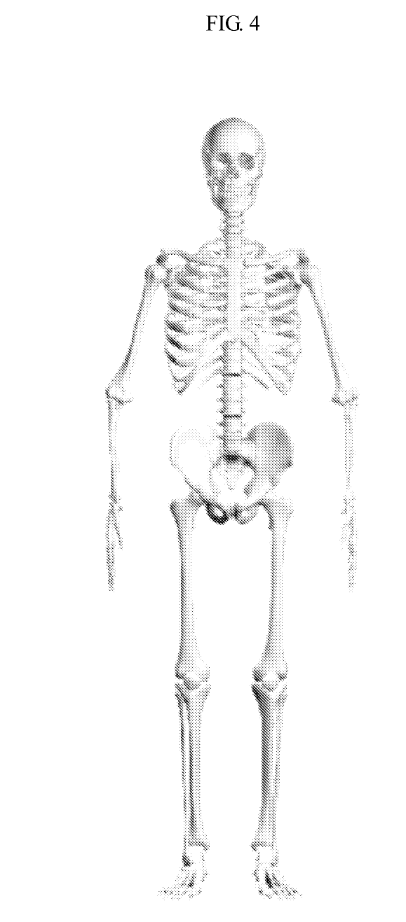

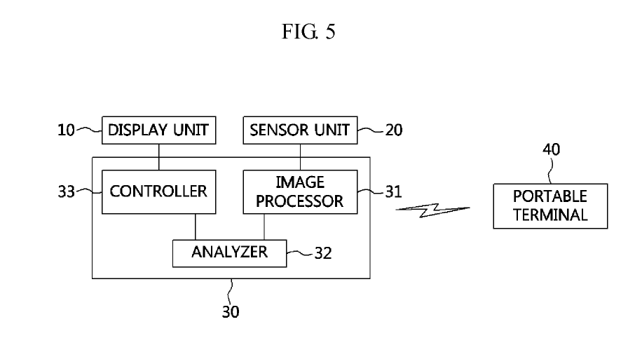

To describe an operation of detecting the skeletal information with reference to FIGS. 2 and 3, the interactive content control method may involve analyzing which part of a body the body image information (detected in operation 110) corresponds to, in which case the interactive content control method may involve analyzing which part of the body the body image information corresponds to on the basis of the overall appearance of the body image information. Analyzing FIG. 2, it can be seen that the body image information indicates a person's upper body, and the interactive content control method detects skeletal information on the person's upper body according to the analysis result. Furthermore, in a case where basic skeletal information of a person illustrated in FIG. 4 is previously stored in a database (not shown), when the body image information is analyzed as indicating the person's upper body, the interactive content control method involves extracting upper body skeletal information corresponding to the body image information from the basic skeletal information of the person stored in the database (not shown), correcting the extracted upper body skeletal information to be suitable for the ratio and movement state of the body image information, and using the corrected skeletal information as the skeletal information detected in operation 120. In this case, the skeletal information may be schematically shown as illustrated in FIG. 3.

In operation 120, a scheme of detecting the skeletal information is not limited to the above description, and the skeletal information may be detected by various schemes.

Operation 130 is an operation of extracting the reference joint and the reference bones connected to the reference joint on the basis of the skeletal information detected in operation 120. The reference joint and the reference bones are extracted by the image processor 31 (see FIG. 5). Here, the reference joint and the reference bones denote a joint and bones that are relevant to the user's movement corresponding to a command for controlling the interactive content. For example, when the interactive content is controlled according to a command corresponding to the user's arm movement, the reference joint denotes the arm's elbow, and the reference bones denote bones connected to the arm's elbow.

Operation 130 involves extracting the at least one reference joint and the at least two reference bones that are connected to the reference joint from the skeletal information detected in operation 120. Referring to FIG. 3, operation 130 involves first extracting a reference joint corresponding to an elbow, extracting one reference bone that extends from the elbow to a shoulder, and extracting one reference bone that extends from the elbow to a wrist. The reference joint and the reference bones connected to the reference joint that are extracted in operation 130 are not limited to the above description.

Operation 140 is an operation of detecting the reference length on the basis of the reference joint and the reference bones extracted in operation 130. The reference length is detected by the image processor 31 (see FIG. 5). Referring to FIG. 3, operation 140 involves detecting a length “L₁” of a first reference bone connected to one end of the reference joint, detecting a length “L₂” of a second reference bone connected to the other end of the reference joint, and detecting the reference length by adding the length “L₁” of the first reference bone to the length “L₂” of the second reference bone.

Step 200 is an operation of detecting the comparison length on the basis of the reference joint and the reference bones extracted in operation 130. The comparison length is detected by the image processor 31 (see FIG. 5). Referring to FIG. 3, step 200 involves detecting, as the comparison length, a linear length “L₃” between an end portion of the first reference bone connected to one end of the reference joint and an end portion of the second reference bone connected to the other end of the reference joint.

Step 300 is an operation of controlling interactive content according to the result of comparing the reference length and the comparison length. Step 300 includes: operation 310 of comparing the size of the reference length and the size of the comparison length; and operation 320 of controlling the interactive content according to a command corresponding to the user's movement when the comparison result shows that the comparison length is greater than or equal to the reference length.

Operation 310 is an operation of comparing the reference length (detected in step 100) and the comparison length (detected in step 200). The reference length and the comparison length are compared by an analyzer 32 (see FIG. 5). That is, step 300 is an operation of determining whether the comparison length is greater than or equal to the reference length.

Referring to FIG. 3, when the reference joint (i.e., elbow) is folded, the comparison length “L₃” is less than the reference length “L₁+L₂”, and when the reference joint (i.e., elbow) is unfolded, the comparison length “L₃” is equal to the reference length “L₁+L₂”. On the basis of this condition, therefore, operation 310 involves comparing the size of the reference length and the size of the comparison length. In this case, when the comparison length “L₃” is greater than or equal to the reference length “L₁+L₂”, the interactive content control method proceeds to operation 320, and when the comparison length “L₃” is less than the reference length “L₁+L₂”, the interactive content control method proceeds to step 100.

Operation 320 is an operation of controlling the interactive content according to the result of comparison in operation 310. The interactive content is controlled by a controller 33 (see FIG. 5). Operation 320 involves controlling the interactive content according to a command corresponding to the user's movement when the comparison result shows that the comparison length is greater than or equal to the reference length. For example, a command for selecting a certain portion of the interactive content is set to be provided when the user unfolds his/her arm, and when the comparison result of operation 310 shows that the comparison length “L₃” is greater than or equal to the reference length “L₁+L₂”, the command for selecting the certain portion of the interactive content is provided, and the interactive content is controlled according to the provided command.

The above description concerns the interactive content control method according to an embodiment of the present invention. Hereinafter, the configuration of a user interface apparatus according to an embodiment of the present invention will be described in detail.

FIG. 5 is a block diagram illustrating a configuration of a user interface apparatus according to an embodiment of the present invention.

Referring to FIG. 5, the user interface apparatus according to an embodiment of the present invention includes: a display unit 10 that displays interactive content which is controlled according to a command corresponding to a user's movement; a sensor unit 20 that detects body image information based on the user's movement; and an interface unit 30 that detects skeletal information on the basis of the detected body image information, detects a reference length and a comparison length on the basis of the skeletal information, compares the reference length and the comparison length, and controls the interactive content displayed by the display unit 10 according to the comparison result.

The user interface apparatus further includes a portable terminal 40 that is connected to the interface unit 30 over a communication network, and displays the interactive content which is controlled according to the command corresponding to the user's movement. The interactive content displayed by the portable terminal 40 is controlled by the interface unit 30.

The portable terminal 40 may further include a function that transmits a control signal for controlling the interactive content to the interface unit 30 according to the user's request, and displays the interactive content controlled by the interface unit 30 according to the control signal.

The display unit 10 displays the interactive content controlled according to the command corresponding to the user's movement, and the command for controlling the interactive content is provided to the interface unit 30.

The sensor unit 20 is an element that detects body image information based on the user's movement. The sensor unit 20 may detect only the body image information of the user, or detect the body video information of the user and then detect body image information from the detected body video information. The body image information detected by the sensor unit 20 is provided to the image processor 31 of the interface unit 30. Here, a two-dimensional (2D) camera, a three-dimensional (3D) camera or the like may be used as the sensor unit 20.

Moreover, the interactive content is controlled according to a command corresponding to the user's movement, and thus, the sensor unit 20 detects the body image information on the user's movement corresponding to a command for controlling the interactive content. For example, when the interactive content is controlled according to a command corresponding to the user's arm movement, the sensor unit 20 detects body image information including the user's arm, and when the interactive content is controlled according to a command corresponding to the user's leg movement, the sensor unit 20 detects body image information including the user's leg.

The interface unit 30 may include an image processor 31, an analyzer 32, and a controller 33. The image processor 31 detects skeletal information on the basis of the body image information detected by the sensor unit 20, detects a reference joint and reference bones on the basis of the detected skeletal information, and detects a reference length and a comparison length on the basis of the detected reference joint and reference bones.

To describe an operation of detecting the skeletal information with reference to FIGS. 2 and 3, the user interface apparatus may analyze which part of a body the body image information (detected by the sensor unit 20) corresponds to, in which case the user interface apparatus may analyze which part of the body the body image information corresponds to on the basis of the overall appearance of the body image information. Analyzing FIG. 2, it can be seen that the body image information indicates a person's upper body, and the user interface apparatus detects skeletal information on the person's upper body according to the analysis result. Furthermore, in a case where the basic skeletal information of the person illustrated in FIG. 4 is previously stored in the database (not shown), when the body image information is analyzed as indicating the person's upper body, the user interface apparatus extracts upper body skeletal information corresponding to the body image information from the basic skeletal information of the person stored in the database (not shown), corrects the extracted upper body skeletal information to be suitable for the ratio and movement state of the body image information, and uses the corrected skeletal information as the skeletal information detected by the image processor 31. In this case, the skeletal information may be schematically shown as illustrated in FIG. 3.

A scheme in which the image processor 31 detects skeletal information is not limited to the above description, and the image processor 31 may detect the skeletal information in various schemes.

The image processor 31 extracts the at least one reference joint and the at least two reference bones that are connected to the reference joint from the detected skeletal information. The reference joint and the reference bones denote a joint and bones that are relevant to the user's movement corresponding to a command for controlling the interactive content. For example, when the interactive content is controlled according to a command corresponding to the user's arm movement, the reference joint denotes the arm's elbow, and the reference bones denotes bones connected to the arm's elbow. Referring to FIG. 3, the image processor 31 first extracts a reference joint corresponding to an elbow, extracts one reference bone that extends from the elbow to a shoulder, and extracts one reference bone that extends from the elbow to a wrist. The reference joint and the reference bones connected to the reference joint that are extracted by the image processor 31 are not limited to the above description.

The image processor 31 detects the reference length on the basis of the detected reference joint and reference bones. Referring to FIG. 3, the image processor 31 detects the length “L₁” of the first reference bone connected to one end of the reference joint, detects the length “L₂” of the second reference bones connected to the other end of the reference joint, and detects the reference length by adding the length “L₁” of the first reference bone to the length “L₂” of the second reference bone.

The image processor 31 detects the reference length on the basis of the extracted reference joint and reference bones. Referring to FIG. 3, the image processor 31 detects, as the comparison length, the linear length “L₃” between an end portion of the first reference bone connected to one end of the reference joint and an end portion of the second reference bone connected to the other end of the reference joint. The reference length and comparison length detected by the image processor 31 are provided to the analyzer 32.

The analyzer 32 compares the sizes of the reference length and comparison length detected by the image processor 31. Referring to FIG. 3, when the reference joint (i.e., elbow) is folded, the comparison length “L₃” is less than the reference length “L₁+L₂”, and when the reference joint (i.e., elbow) is unfolded, the comparison length “L₃” is equal to the reference length “L₁+L₂”. On the basis of this condition, therefore, the analyzer 32 compares the size of the reference length and the size of the comparison length, and provides the comparison result to the controller 33.

The controller 33 controls the interactive content according to the result of comparison by the analyzer 32. That is, the controller 33 controls the interactive content according to a command corresponding to the user's movement when the comparison length is greater than or equal to the reference length. For example, a command for selecting a certain portion of the interactive content is set to be provided when the user unfolds his/her arm, and when the result of comparison by the analyzer 32 shows that the comparison length “L₃” is greater than or equal to the reference length “L₁+L₂”, the controller 33 performs control to select the certain portion of the interactive content.

The portable terminal 40 is connected to the interface unit 30 over the communication network, and displays the interactive content which is controlled according to the command corresponding to the user's movement. The interactive content displayed by the portable terminal 40 is controlled by the interface unit 30. Any communication-enabled terminal, such as a smart phone, a tablet computer, a personal digital assistant (PDA), etc., may be used as the portable terminal 40.

The portable terminal 40 displays the interactive content controlled by the interface unit 30 according to a command corresponding to the user's movement, and may further include a function of transmitting a control signal for controlling the interactive content to the interface unit 30 according to the user's request and displaying the interactive content controlled by the interface unit 30 according to the control signal. Here, the control signal may be generated by a physical interface apparatus (for example, a keypad, a touch screen, etc.) included in the portable terminal 40. Also, as described above, the portable terminal 40 detects skeletal information on the basis of the body image information detected by a camera included in the portable terminal 40, detects a reference joint and reference bones on the basis of the detected skeletal information, and detects a reference length and a comparison length on the basis of the detected reference joint and reference bones.

Moreover, the interface unit 30 may control the interactive content displayed by the portable terminal 40 according to the control signal received from the portable terminal 40, and control the interactive content displayed by the display unit 10. That is, the control signal transmitted from the portable terminal 40 to the interface unit 30 according to the user's request may simultaneously control the interactive content displayed by the portable terminal 40 and the interactive content displayed by the display unit 10.

According to the example embodiments of the present invention, by controlling interactive content on the basis of skeletal information that changes according to a user's movement, the interactive content control method and the user interface apparatus can provide a more interactive user interface environment than a conventional method of controlling content with a keyboard, a mouse, or a touch screen.

While example embodiments of the present invention and their advantages have been described in detail, it should be understood that various changes, substitutions and alterations may be made herein without departing from the scope of the invention.

What is claimed is:

1. An interactive content control method performed by a user interface apparatus, the interactive content control method comprising:
detecting a reference length which becomes a reference for controlling interactive content according to a movement of a user, on the basis of skeletal information of the user;
detecting a comparison length on the basis of the skeletal information; and
controlling the interactive content according to a result of comparing the reference length and the comparison length.

2. The interactive content control method of claim 1, wherein the detecting of the reference length comprises:
detecting body image information of the user;
detecting the skeletal information of the user on the basis of the detected body image information;
extracting at least one reference joint and at least two reference bones that are connected to the reference joint from the detected skeletal information; and
detecting a value obtained by adding a length of a first reference bone connected to one end of the reference joint to a length of a second reference bone connected to the other end of the reference joint as the reference length.

3. The interactive content control method of claim 2, wherein the detecting of the comparison length comprises detecting a linear length between an end portion of a first reference bone connected to one end of the reference joint and an end portion of a second reference bone connected to the other end of the reference joint as the comparison length.

4. The interactive content control method of claim 1, wherein the controlling of the interactive content comprises:
comparing a size of the reference length and a size of the comparison length; and
controlling the interactive content according to a command corresponding to the movement of the user when the comparison length is greater than or equal to the reference length as the comparison result.

5. A user interface apparatus comprising:
a display unit configured to display interactive content controlled according to a command corresponding to a movement of the user;
a sensor unit configured to detect body image information based on the movement of the user; and
a user interface configured to detect skeletal information on the basis of the body image information detected by the sensor unit, detect a reference length and a comparison length on the basis of the skeletal information, compare the reference length and the comparison length, and control the interactive content displayed by the display unit according to the comparison result.

6. The user interface apparatus of claim 5, further comprising a portable terminal connected to the interface unit over a communication network and configured to display the interactive content controlled according to the command corresponding to the movement of the user,
wherein the interactive content displayed by the portable terminal is controlled by the interface unit.

7. The user interface apparatus of claim 6, wherein the portable terminal further comprises a function which transmits a control signal for controlling the interactive content to the interface unit according to a request of the user and displays the interactive content controlled by the interface unit according to the control signal.

8. The user interface apparatus of claim 5, wherein the interface unit extracts at least one reference joint and at least two reference bones connected to the reference joint from the skeletal information, detects a value obtained by adding a length of a first reference bone connected to one end of the reference joint to a length of a second reference bone connected to the other end of the reference joint, as the reference length, and detects a linear length between an end portion of a first reference bone connected to one end of the reference joint and an end portion of a second reference bone connected to the other end of the reference joint as the comparison length.

9. The user interface apparatus of claim 8, wherein the interface unit controls the interactive content according to the command corresponding to the movement of the user when the comparison length is greater than or equal to the reference length as a result of the comparison.
